(19) United States
(12) Patent Application Publication
(10) Pub. No.: US 2022/0129852 A1
(43) Pub. Date: Apr. 28, 2022

(54) CROSS-ENTITY PROCESS COLLABORATION SERVICE VIA SECURE, DISTRIBUTED LEDGER

(71) Applicant: SAP SE, Walldorf (DE)

(72) Inventors: Jose Prados, Heidelburg (DE); Andreas Krompholz, Heidelberg (DE)

(21) Appl. No.: 17/081,629

(22) Filed: Oct. 27, 2020

(51) Int. Cl. G06Q 10/10; H04L 9/08; H04L 29/06; H04L 9/06

(52) U.S. Cl. CPC G06Q 10/101; H04L 9/0866; H04L 2209/38; H04L 9/0643; H04L 63/102

(57) ABSTRACT

Embodiments may be associated with a secure, distributed transaction ledger. The system may include a collaboration scenario template data store that contains electronic records providing entity identifiers and a set of task templates. A computer processor of a cross-entity process collaboration platform, coupled to the collaboration scenario template data store, may access information in the collaboration scenario template data store. The cross-entity process collaboration platform may then automatically create a collaboration scenario based on the entity identifiers and the set of task templates. The collaboration scenario may then be deployed by the cross-entity process collaboration platform to the secure, distributed transaction ledger.

### BACKGROUND

Business processes today may be conducted across different entities (e.g., companies or business organizations) that join forces to work on common goals and responsibilities. Individual corporate interests and different regulations and structures may make the orchestration of such cross-company collaboration processes difficult, when can help generate a demand for clear and transparent understanding about how to collaborate e.g., which tasks must be performed, terms and conditions, deadlines, etc.). Entities may also want to document an entire collaboration into a shared and undeniable audit trail (that every entity can always trust and leverage) which could automatically trigger internal processes, actions, events, payments, etc. based on such secured and trustworthy interactions as part of a cross-company collaboration process. Also note that collaborations between different entities may be subject to frequent evolution, which cannot be easily captured at the beginning of the process. Being able to flexibility adapt to those changes (adding new organizations, creating new tasks, arranging for follow-up tasks or events, etc.) in a cross-entity collaboration process can be a time consuming and error-prone process, especially when a substantial number of entities are involved.

It would therefore be desirable to automatically provide for cross-entity collaboration using a secure, distributed transaction ledger in an efficient and accurate manner.

### SUMMARY

According to some embodiments, methods and systems may provide for cross-entity collaboration using a secure, distributed transaction ledger. A system may include a collaboration scenario template data store that contains electronic records providing entity identifiers and a set of task templates. A computer processor of a cross-entity process collaboration platform, coupled to the collaboration scenario template data store, may access information in the collaboration scenario template data store. The cross-entity process collaboration platform may then automatically create a collaboration scenario based on the entity identifiers and the set of task templates. The collaboration scenario may then be deployed by the cross-entity process collaboration platform to the secure, distributed transaction ledger.

Some embodiments comprise: means for accessing information in a collaboration scenario template data store, the collaboration scenario template data store containing electronic records that provide entity identifiers and a set of task templates; means for automatically creating, by a computer processor a cross-entity process collaboration platform, a collaboration scenario based on the entity identifiers and the set of task templates; and means for deploying the collaboration scenario via a secure, distributed transaction ledger.

Some technical advantages of some embodiments disclosed herein are improved systems and methods that provide for cross-entity collaboration using a secure, distributed transaction ledger in an efficient and accurate manner.

### BRIEF DESCRIPTION OF THE DRAWINGS

FIG. 1 is a high-level block diagram of a system in accordance with some embodiments.

FIG. 2 illustrates a method to provide cross-entity collaboration using a secure, distributed transaction ledger according to some embodiments.

FIG. 3 shows a collaboration system in accordance with some embodiments.

FIG. 4 shows design time and runtime data structures according to some embodiments.

FIG. 5 is a collaboration data flow in accordance with some embodiments.

FIG. 6 is a blockchain network according to some embodiments.

FIG. 7 is a more detailed block diagram of a system according to some embodiments.

FIGS. 8 and 9 are human machine interface displays according to some embodiments.

FIG. 10 illustrates a business process management system in accordance with some embodiments.

FIG. 11 is an apparatus or platform according to some embodiments.

FIG. 12 illustrates a collaboration scenario database in accordance with some embodiments.

FIG. 13 illustrates a handheld tablet computer according to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developer's specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

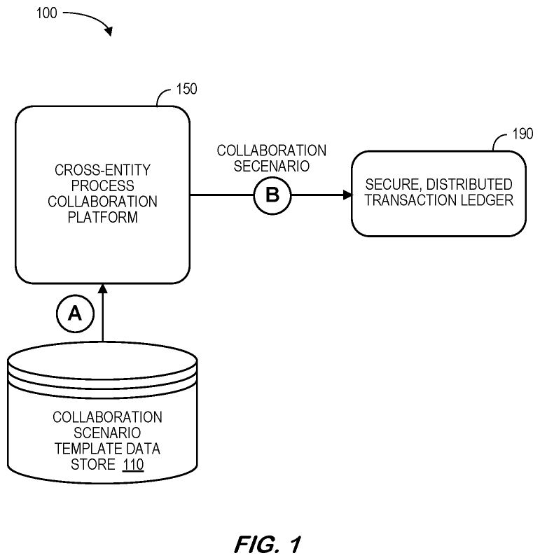

FIG. 1 is a high-level block diagram of a system 100 according to some embodiments. At (A), a cross-entity process collaboration platform 150 may access information in a collaboration scenario template data store 110. According to some embodiments, the “automated” cross-entity process collaboration platform 150 may receive information about entity identifiers and a set of risk templates and automatically create a collaboration scenario. A used herein, the term “automated” may refer to a device or process that can operate with little or no human interaction. At (B), the collaboration scenario may be stored via a secure, distributed transaction ledger 190, such as one that uses “blockchain” technology. A blockchain is a growing list of records (“blocks”) that are linked using cryptography. Each block may contain a cryptographic hash of the previous block, a timestamp, and transaction data (e.g., represented as a Merkle tree). Because it is decentralized and distributed, a blockchain may provide resistance to data modification. It may represent an open, distributed ledger that can record transactions between two parties efficiently and in a verifiable and permanent way. For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority. Blockchains are considered secure by design and exemplify a distributed computing system with high fault tolerance.

According to some embodiments, devices, including those associated with the system 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The elements of the system 100 may store information into and/or retrieve information from various data stores (e.g., the collaboration scenario template data store 110), which may be locally stored or reside remote from the cross-entity process collaboration platform 150. Although a single cross-entity process collaboration platform 150 is shown in FIG. 1, any number of such devices may be included. Moreover, various devices described herein might be combined according to embodiments of the present invention. For example, in some embodiments, the cross-entity process collaboration platform 150 and collaboration scenario template data store 110 might comprise a single apparatus. Some or all of the system 100 functions may be performed by a constellation of networked apparatuses, such as in a distributed processing or cloud-based architecture.

A user (e.g., an operator or administrator) may access the system 100 via a remote device (e.g., a Personal Computer (“PC”), tablet, or smartphone) to view information about and/or manage operational information in accordance with any of the embodiments described herein. In some cases, an interactive graphical user interface display may let an operator or administrator define and/or adjust certain parameters (e.g., to setup company relationships) and/or provide or receive automatically generated recommendations or results from the system 100.

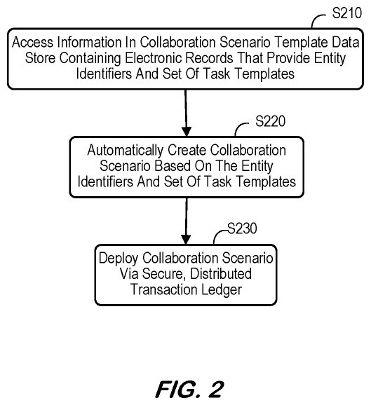

FIG. 2 illustrates a method to provide cross-entity collaboration using a secure, distributed transaction ledger (e.g., a secure, distributed “block file” system or simply a secure, distributed system) according to some embodiments. The flow charts described herein do not imply a fixed order to the steps, and embodiments of the present invention may be practiced in any order that is practicable. Note that any of the methods described herein may be performed by hardware, software, an automated script of commands, or any combination of these approaches. For example, a computer-readable storage medium may store thereon instructions that when executed by a machine result in performance according to any of the embodiments described herein.

At S210, a cross-entity process collaboration platform may access information in a collaboration scenario template data store (e.g., a database) that contains electronic and/or encrypted records providing entity identifiers (e.g., each being associated with an object such as a company, a business, a supplier, a buyer, a manufacturer, a distributer, an enterprise, etc.) and a set of task templates (e.g., with each risk template being a pattern or workflow that is associated with a task or process). According to some embodiments, the electronic records further include a collaboration scenario description (e.g., describing the purpose of the collaboration). Moreover, each task template may include a task or process identifier, a task or process description, a due date, a receiver identifier, a context attribute, etc.

At S220, the cross-entity process collaboration platform may automatically create a collaboration scenario (or “object state”) based on the entity identifiers and the set of task templates (e.g., after decrypting the information in the database). At S230, the system may deploy the collaboration scenario by transmitting it to a secure, distributed transaction ledger (e.g., associated with blockchain technology). In some embodiments, the information may be encrypted before being deployed via blockchain. Multiple entities can then use the collaboration scenario to work together and perform a collaborative task. As will be described, some embodiments may further include a user experience interface and/or an audit trail interface.

Note that some embodiments described herein may provide a benefit of leveraging a blockchain to orchestrate cross-company business processes. Because blockchain is a reliable, difficult-to-hack record of transactions, based on distributed ledger technology, it can securely record information across a peer-to-peer network. A distributed ledger is a database of transactions that is shared and synchronized across multiple computers and locations—without centralized control. Each party owns an identical copy of the records, which is automatically updated as soon as any additions are made resulting in a collection of “blocks” recorded in a chronological “chain” that cannot be altered, i.e. in a tamper-proof and irrevocable manner.

Leveraging blockchain to build a multi-tiered network of organizations collaborating on a common goal or responsibility can speed up collaboration in multi-party scenarios—and allow for faster transactions that aren't limited by office hours. As information in blockchains is viewable by all participants and cannot be altered, it reduces risk and fraud and creates trust between entities.

Some embodiments may bring a structure for collaborative activities across multiple organizations. A cross-company collaboration process may, for example, take place when corporate bodies or offices from different organizations (supplier, manufacturer, engineer, etc.) join forces to work on a common goal, project, or responsibility. Although every organization will represent individual corporate interests, these collaborative activities (as well as their common goals or responsibilities and the consequences regarding their fulfilment) should be clear and transparent to everyone involved.

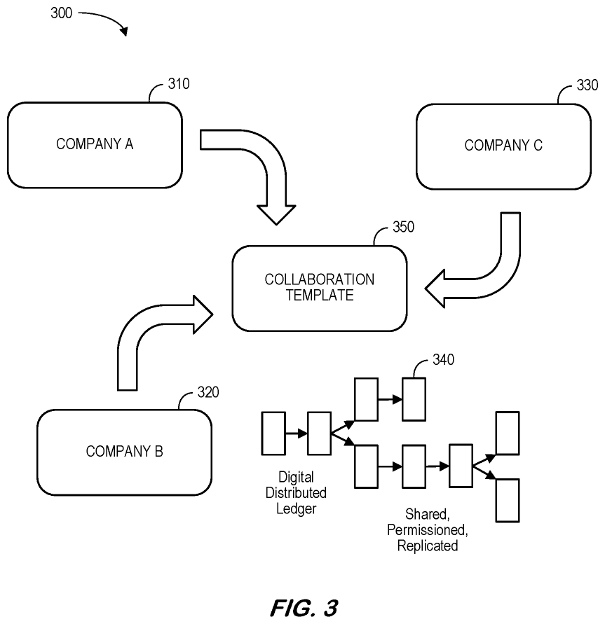

FIG. 3 shows a collaboration system 300 for company A 310, company B 320, and company C 330 in accordance with some embodiments. Some embodiments utilize a collaboration scenario template 305 as the representation of a target situation of a cross-company collaboration scenario at a particular point in time. This template 350 may be stored as blocks 340 in a blockchain that includes the organizations involved in the scenario as well as a collection of task templates representing activities with a specific purpose (description), an associated completion due date, and a context to be used within this task template. The different contexts to be considered in the collaboration scenario may comprise entity objects, such as purchase orders, documents, or materials that contain relevant information required when reporting the completion of collaborative tasks. A task template may, in some embodiments, be linked to multiple confirmation requests (receivers) to provide additional cross-company task confirmation.

Storing cross-company collaboration scenario templates 350 via blockchain 3440 may make it easier to get the companies 310, 320, 330 to be part of a multi-tiered blockchain network to trust and verify what happened in collaboration scenarios based on such templates (as they refer to the same single point of truth). As the cross-company collaboration process progresses, every collaborative task that an organization completes may be stored on the blockchain as well (as part of the actual situation of the collaboration process) resulting in the audit trail (e.g., a trustworthy and undeniable end-to-end documentation of the cross-company interactions that span across the multi-tiered network of process participants).

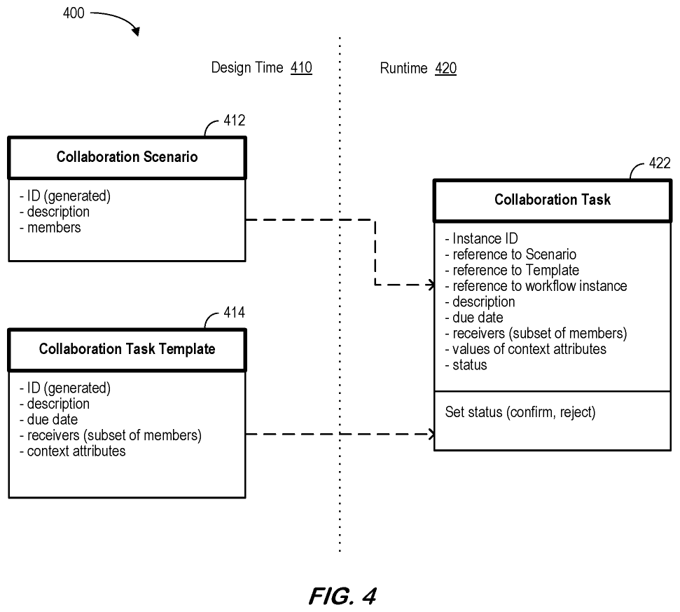

FIG. 4 shows 400 design time 410 and runtime 420 data structures according to some embodiments. The design time data structures 410 include a collaboration scenario 412 (e.g., with generated identifiers, a description, members, etc.) and a collaboration task template 414 (e.g., with generated identifiers, a description, a due date, receivers (a subset of the members), context attributers, etc.). The runtime data structure 420 comprises a collaboration task 422 (with information based on the collaboration scenario 412 such as an instance identifier, a reference to the scenario, a reference to the template, a reference to a workflow instance, a description, a due date, a receivers (a subset of the members), values of context attributes, a status, etc.). The collaboration task 422 may also have information based on the collaboration task template 414, such as a status (e.g., confirm or reject).

Having the target situation stored on the collaboration template and the actual one stored on the audit trail, it is easy for all involved organizations to verify the completion of activities according to the agreed deadline and any required cross-company confirmations. Defining such collaborative activities in this way may increase the visibility and transparency of the whole collaboration process, creating a single point of truth that everyone can leverage to verify the completion of activities and their cross-company confirmations and, based on this, automatically trigger internal specific follow-up activities (e.g., payment, shipment, follow-up tasks, etc.).

In this way, embodiments may provide a new blockchain-secured cross-company workflow collaboration service on a cloud platform. Some embodiments utilize a business integration service leveraging blockchain to provide organizations with:
An easy way of defining, maintaining and consuming cross-company collaboration scenario templates with business peers.
A flexible and easy-to-adapt integration of cross-company collaborative tasks into internal business processes.
A trustworthy end-to-end documentation of collaboration that span across a multi-tiered network of organizations.

Such a blockchain-based service may establish a bridge between collaborating organizations to orchestrate different internal processes involved on one side and provide flexibility when adapting collaboration scenarios to accommodate changing conditions on the other side.

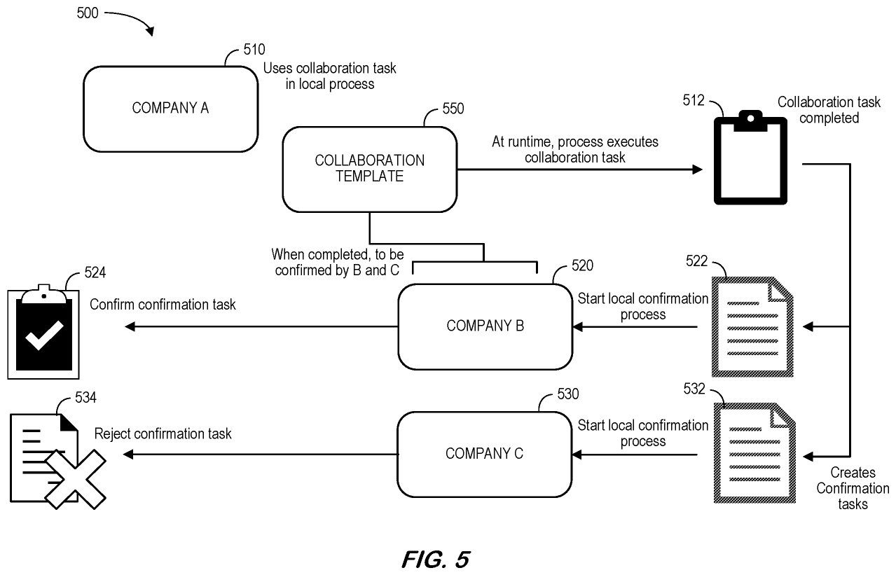

FIG. 5 is a collaboration data flow 500 between three business peers (company A 510, company B 520, and company C 530) in accordance with some embodiments. A collaboration template 550 contains the three organizations involved in the collaboration scenario and one task template with two confirmation requests assigned to two members. Company A 510 will then execute the collaborative task 512 represented by the task template from a local process by using the new blockchain integration service, which is connected to the blockchain network. Using blockchain and the blockchain integration service, Companies B and C 520, 530 can be then notified 522, 532 about the incoming collaborative task completed by Company A 510 and are able to react to this task by triggering a process locally maintained in the collaboration template. The companies 520, 530 can then either confirm 524 or reject 534 completion of the task. This approach may facilitate the orchestration of local business processes of multiple organizations to leverage the collaboration scenario template as “collaboration contract” to follow when the organizations interact (collaborate) with each other.

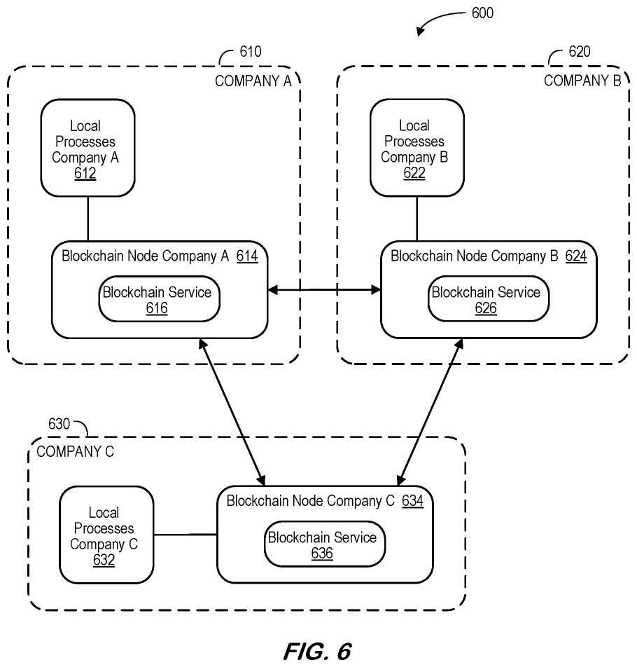

FIG. 6 is a blockchain network 600 according to some embodiments. The network 600 includes components associated with company A 610 including local processes 612 and a blockchain node 614 (e.g., to work with other companies in accordance with any of the embodiments described herein). Similarly, the network 600 includes components associated with company B 620 (including local processes 622 and a blockchain node 624) and with company C 630 (including local processes 632 and a blockchain node 634). Note that blockchain is a distributed network platform that can be used to store and share data across company borders. The network 600 consists of a set of blockchain nodes 614, 624, 634 and associated blockchain services 616, 626, 646 that exchange information and each node 614, 624, 634 is usually assigned to one participating company. The blockchain protocol takes care of synchronizing the content of each node 614, 624, 634 to get a commonly agreed state of the network data. The openness of blockchain is a key capability of the technology that implies that every participant can store data on the blockchain network 600 without involving any central server for validations of the written content.

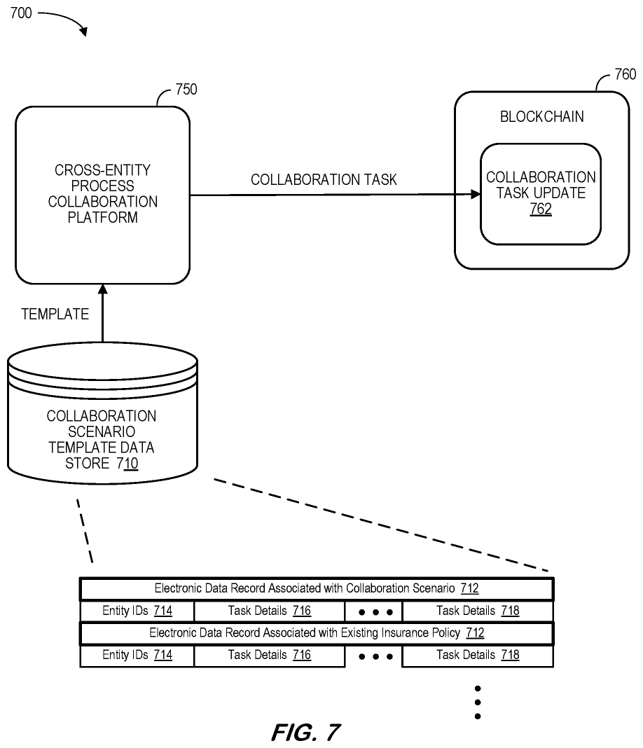

FIG. 7 is a more detailed block diagram of a system 700 according to some embodiments. As before, a cross-entity process collaboration platform 750 may access information in a collaboration scenario template data store 710. The collaboration scenario template data store 710 may contain electronic records 712 and each record 712 may include enterprise identifiers 714 and collaborative task details 716, 718. The collaboration scenario may then be stored via a blockchain 760 to support future collaboration task updates 762 by those enterprises.

Some embodiments may maintain collaboration scenario templates and an audit trail. For example, as part of a cloud service embodiments may provide a user experience application that lets collaborating organizations work as part of a multi-tiered blockchain network to easily maintain cross-company collaboration templates. Also, the adaptation of such templates may allow for future process changes (e.g., new members, contexts, task templates, confirmation requests, etc.). To give each party involved in a collaboration necessary transparency, every change on the collaboration template may also be protocoled to the blockchain.

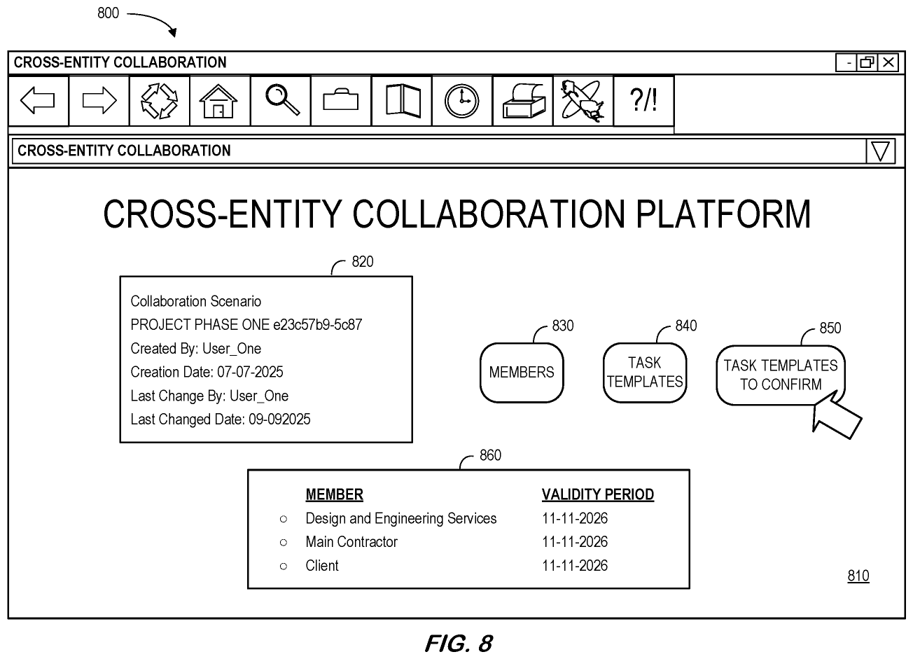

FIG. 8 is a human machine interface display 800 in accordance with some embodiments. The display 800 includes a graphical representation 810 or dashboard that might be used to manage or monitor a blockchain collaboration framework (e.g., associated with a secure, distributed transaction ledger). In particular, selection of an element (e.g., via a touchscreen or computer mouse pointer) might result in the display of a popup window that contains configuration data. As shown in FIG. 8, the display 800 may include a “collaboration scenario” portion 820 with a project name and details. The display 800 may also include a user selectable “members” icon 830, a “task templates” icon 840, and a “task templates to confirm” icon 850 to navigate through the interface. A “member display” portion 860 might provide information about members who are collaborating.

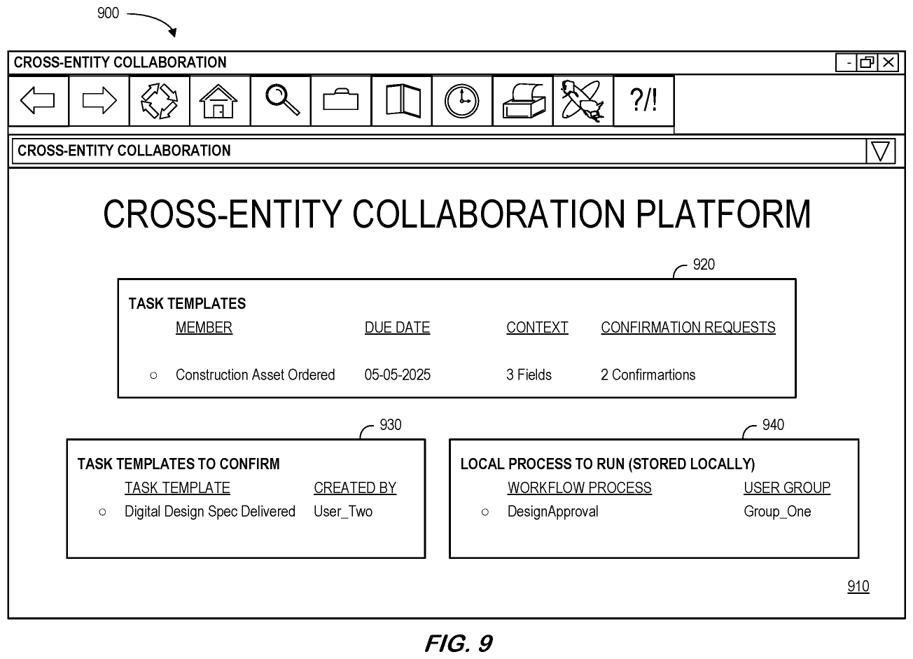

FIG. 9 is another display 900 that includes a “task templates” portion 920 showing (for each task) a member, a description, dude date, context attributes, and confirmation requests. The display 900 also includes a “task templates to confirm” portion 930 with a task template description and creator. Finally, the display 900 includes a “local processes to run” portion 940 (stored locally) with a workflow process name and user group. The ability to determine which local process will execute when another business peer reports the completion of a collaboration task may help enable orchestration of a local business process as part of a cross-company business process. A second user experience may maintain the audit trail of cross-company collaboration scenarios. For each collaboration scenario, embodiments may let a business user visualize the end-to-end documentation of the cross-company interactions across a multi-tiered network of process participants in a trustworthy and tamper-proof way.

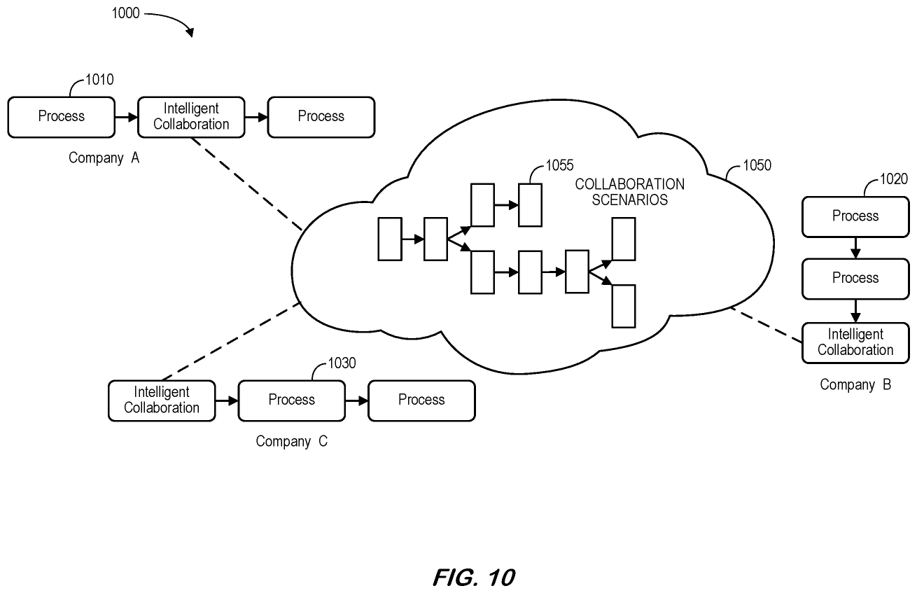

One target group of collaborators are customers who already use a cloud platform workflow for business processes but need cross-company workflow capabilities to extend their scenarios. For example, embodiments may complement an intelligent Business Process Management (“BPM”) strategy enabling business process experts with a flexible and easy-to-adapt integration of cross-company collaborative tasks in complex processes. For example, FIG. 10 illustrates a business process management system 1000 in accordance with some embodiments. Multiple BPM processes 1010, 1020, 1030 (associated with multiple companies) may utilize blockchain based compilation scenarios 1055 in the cloud 1050 to collaborate. Providing the cross-company collaboration task (“intelligent collaboration” in FIG. 10) as part of a library of reusable steps within a BPM process may speed-up complex process implementation and lower the entry barrier for digitizing and automating business process (e.g., a “low-code” approach).

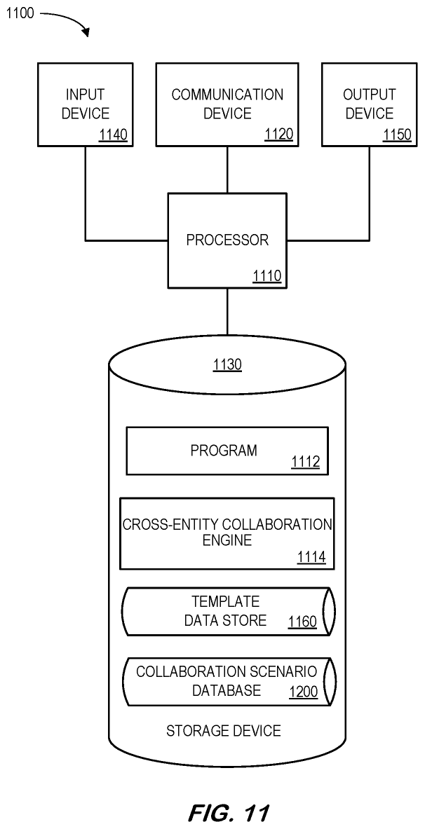

Note that the embodiments described herein may be implemented using any number of different hardware configurations. For example, FIG. 11 is a block diagram of an apparatus or platform 1100 that may be, for example, associated with the system 100 of FIG. 1 (and/or any other system described herein). The platform 1100 comprises a processor 1110, such as one or more commercially available CPUs in the form of one-chip microprocessors, coupled to a communication device 1120 configured to communicate via a communication network (not shown in FIG. 11). The communication device 1120 may be used to communicate, for example, with one or more remote user platforms, collaboration scenario template data stores, etc. The platform 1100 further includes an input device 1140 (e.g., a computer mouse and/or keyboard to input information about collaboration preferences) and an output device 1150 (e.g., a computer monitor to render a display, transmit recommendations or alerts, and/or create collaboration reports). According to some embodiments, a mobile device and/or PC associated with an operator or administrator may be used to exchange information with the platform 1100.

The processor 1110 also communicates with a storage device 1130. The storage device 1130 can be implemented as a single database or the different components of the storage device 1130 can be distributed using multiple databases (that is, different deployment information storage options are possible). The storage device 1130 may comprise any appropriate information storage device, including combinations of magnetic storage devices (e.g., a hard disk drive), optical storage devices, mobile telephones, and/or semiconductor memory devices. The storage device 1130 stores a program 1112 and/or cross-entity collaboration engine 1114 for controlling the processor 1110. The processor 1110 performs instructions of the programs 1112, 1114, and thereby operates in accordance with any of the embodiments described herein. For example, the processor 1110 may access information in a collaboration scenario template data store. The processor 1110 may then automatically create a collaboration scenario based on entity identifiers and a set of task templates. The collaboration scenario may then be deployed by the processor 1110 to a secure, distributed transaction ledger.

The programs 1112, 1114 may be stored in a compressed, uncompiled and/or encrypted format. The programs 1112, 1114 may furthermore include other program elements, such as an operating system, clipboard application, a database management system, and/or device drivers used by the processor 1110 to interface with peripheral devices.

As used herein, information may be “received” by or “transmitted” to, for example: (i) the platform 1100 from another device; or (ii) a software application or module within the platform 1100 from another software application, module, or any other source.

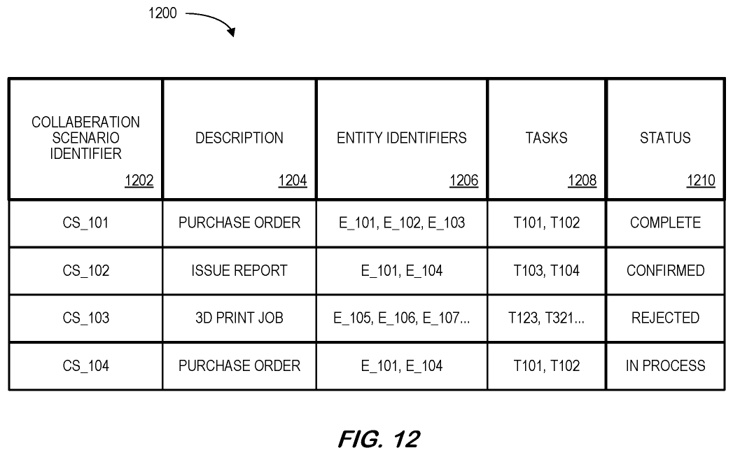

In some embodiments (such as the one shown in FIG. 11), the storage device 1130 further stores a template data store 1160 and a collaboration scenario database 1200. An example of a database that may be used in connection with the platform 1100 will now be described in detail with respect to FIG. 12. Note that the database described herein is only one example, and additional and/or different information may be stored therein. Moreover, various databases might be split or combined in accordance with any of the embodiments described herein.

Referring to FIG. 12, a table is shown that represents the collaboration scenario database 1200 that may be stored at the platform 1100 according to some embodiments. The table may include, for example, entries identifying collaboration scenarios the use blockchain help foster collaborations between multiple entities. The table may also define fields 1202, 1204, 1206, 1208, 1210 for each of the entries. The fields 1202, 1204, 1206, 1208, 1210 may, according to some embodiments, specify: a collaboration scenario identifier 1202, a description 1204, entity identifiers 1206, tasks 1208, and a status 1210. The collaboration scenario data store 1200 may be created and updated, for example, when a collaboration is defined, an existing collaboration scenario is updated, etc.

The smart contact identifier 1202 identifier 1202 might be a unique alphanumeric label or link that is associated with a particular collaboration scenario that utilizes blockchain in accordance with any of the embodiments described herein. The description 1204 may describe and/or define the collaboration. The entity identifiers 1206 might comprise the set of companies who will participate in the collaboration. The tasks 1208 might be associated with a set or sequence of tasks to be performed during the collaboration. The status 1210 might indicate that the collaboration is complete, pending, a task is confirmed or rejected, etc.

In this way, embodiments may provide for cross-entity collaboration using a secure, distributed transaction ledger in an efficient and accurate manner. According to some embodiments, an increase in business may be provided (e.g., because of increase collaborations) along with a reduced time to implement changes to business processes (that is, intelligent collaborations may be deployed and used more quickly).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

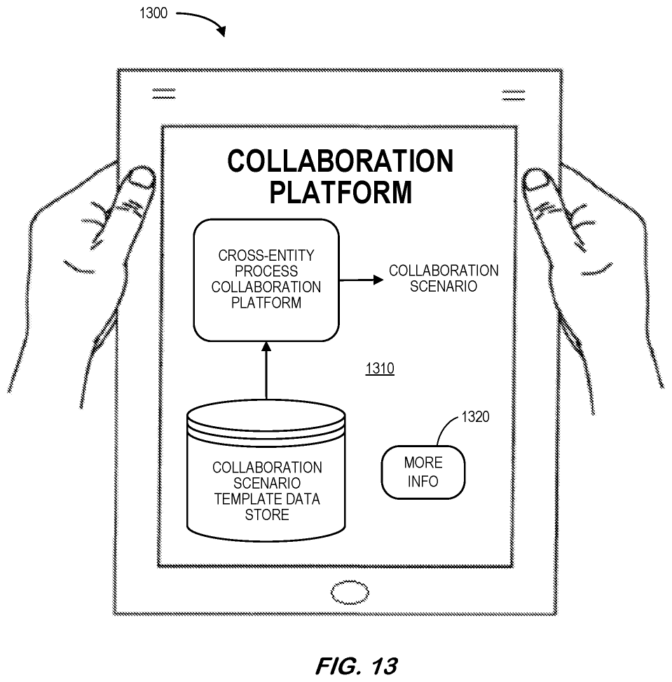

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of blockchain transactions, any of the embodiments described herein could be applied to other types of business functions. Moreover, the displays shown herein are provided only as examples, and any other type of user interface could be implemented. For example, FIG. 13 shows a handheld tablet computer 1300 rendering a collaboration platform display 1310 that may be used to monitor the performance of blockchain framework components and/or to request additional information (e.g., via a “More Info” icon 1320).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. An apparatus associated with a secure, distributed block file system, comprising:
a database storing encrypted records that provide object identifiers and a set of process patterns;
a computer processor coupled to the database, and
a computer memory coupled to the computer processor and storing instructions that, when executed by the computer processor, cause the computer processor to:
access the database,
decrypt the encrypted data,
create an object state based on the object identifiers and sets of process patterns,
encrypt the object state, and
transmit the encrypted object state to the secure, distributed block file system.

2. The apparatus of claim 1, wherein each process pattern includes a process identifier, a process description, a receiver identifier, and a context attribute.

3. The apparatus of claim 2, wherein the object state is subsequently retrieved from the secure, distributed block file system.

4. The apparatus of claim 3, wherein the object state is associated with a set of conditions, and at least one object confirms that the conditions are satisfied.

5. The apparatus of claim 4, wherein a system spans a multi-tiered network.

6. The apparatus of claim 5, wherein changes to a process pattern are transmitted to the secure, distributed block file system.

7. A computer-implemented method associated with a secure, distributed block file system, comprising:
accessing, by a computer processor, a database storing encrypted records that provide object identifiers and a set of process patterns;
decrypting the encrypted data;
creating an object state based on the object identifiers and sets of process patterns;
encrypting the object state; and
transmitting the encrypted object state to the secure, distributed block file system.

8. The method of claim 7, wherein each process pattern includes a process identifier, a process description, a receiver identifier, and a context attribute.

9. The method of claim 8, wherein the object state is subsequently retrieved from the secure, distributed block file system

10. The method of claim 9, wherein a system spans a multi-tiered network.

11. A non-transitory medium storing instructions associated with a secure, distributed block file system, including:
instructions to access, by a computer processor, a database storing encrypted records that provide object identifiers and a set of process patterns;
instructions to decrypt the encrypted data;
instructions to create an object state based on the object identifiers and sets of process patterns;
instructions to encrypt the object state; and
instructions to transmit the encrypted object state to the secure, distributed block file system.

12. The medium of claim 11, wherein each process pattern includes a process identifier, a process description, a receiver identifier, and a context attribute.

13. The medium of claim 12, wherein the object state is subsequently retrieved from the secure, distributed block file system

14. An apparatus associated with a secure, distributed system, comprising:
a database storing encrypted records that provide object identifiers and a set of process patterns;
a computer processor coupled to the database, and
a computer memory coupled to the computer processor and storing instructions that, when executed by the computer processor, cause the computer processor to:
access the database,
decrypt the encrypted data,
create an object state based on the object identifiers and sets of process patterns,
encrypt the object state, and
transmit the encrypted object state to the secure, distributed system.

15. The apparatus of claim 14, wherein each process pattern includes a process identifier, a process description, a receiver identifier, and a context attribute.

16. The apparatus of claim 15, wherein a system spans a multi-tiered network.

17. The apparatus of claim 16, wherein changes to a process pattern are transmitted to the secure, distributed system.
